(19) United States
(12) Patent Application Publication
(10) Pub. No.: US 2010/0101626 A1
(43) Pub. Date: Apr. 29, 2010

(54) SOLAR BATTERY APPARATUS, PORTABLE ELECTRONIC DEVICE, AND GLOBAL POSITIONING SYSTEM APPARATUS

(76) Inventors: Yoshihide Iwazaki, Osaka-shi (JP); Hiroyuki Nakanishi, Osaka-shi (JP); Kohji Miyata, Osaka-shi (JP); Masahiro Okita, Osaka-shi (JP); Hideya Takakura, Osaka-shi (JP)

Correspondence Address: NIXON & VANDERHYE, PC, 901 NORTH GLEBE ROAD, 11TH FLOOR, ARLINGTON, VA, 22203, US

(21) Appl. No.: 12/603,926

(22) Filed: Oct. 22, 2009

(30) Foreign Application Priority Data
Oct. 27, 2008 (JP) 2008-276014

(51) Int. Cl. H02N 6/00

(52) U.S. Cl. 136/244

(57) ABSTRACT

A solar battery apparatus 10 has a plurality of solar battery cells 3 and electrode terminals 4, other than common electrode terminals, for making an electrical connection (i) between each of the solar battery cells 3 and another or (ii) between the solar battery cell 3 and an external apparatus, the solar battery apparatus 10 including: metal wires 5 for making an electrical connection between the solar battery cell 3 and the electrode terminals 4 in a plurality of places on the solar battery cell 3, whereby a decrease in power generation capacity of the solar battery cell 3 is prevented even if the solar battery cell 3 is ruptured by a physical force. This makes it possible to provide a solar battery apparatus in which a decrease in power generation capacity of a solar battery cell can be prevented even if the solar battery cell is ruptured by a physical force.

This Nonprovisional application claims priority under 35 U.S.C. §119(a) on Patent Application No. 2008-276014 filed in Japan on Oct. 27, 2008, the entire contents of which are hereby incorporated by reference.

### TECHNICAL FIELD

The present invention relates to (i) a solar battery apparatus including a solar battery cell, more specifically to a solar battery apparatus in which a decrease in power generation capacity of a solar battery cell is prevented even if the solar battery cell is ruptured by a physical force, (ii) a portable electronic device, and (iii) a global positioning system apparatus.

### BACKGROUND ART

Currently, a portable information electronic device generally operates on a secondary cell serving as a power source of the portable information electronic device. A user plugs the secondary cell to an outlet (a commercial power source) so as to charge the secondary cell via a transformation apparatus or the like, whereby electric power is supplied to the secondary cell. However, in general, it is frequently difficult to obtain a power source when such a portable information electronic device is used. In order to compensate for an amount of charge reduced while the portable information electronic device is being used or carried, charging via a dry cell battery may be employed. As an alternative, a device may also be used (i) which stores, in a secondary cell, electric power generated by a solar battery or (ii) which directly charges the secondary cell via a transformation circuit or the like, other than the portable information electronic device. For such a charging device, it is unnecessary to obtain a commercial power source. On the other hand, it is necessary (i) to carry the charging device with the portable information electronic device or (ii) to physically connect the charging device to an external connecting terminal of the portable information electronic device so as to charge the portable information electronic device. This may cause inconvenience of handling the charging device at least while the portable information electronic device is being moved. In order to avoid such inconvenience, it is suggested that the portable information electronic device be mounted with a solar battery.

A portable information electronic device is expected to be more and more important as a daily necessity in the future. Note, however, that it is necessary to further reduce the portable information electronic device in size and weight. Note also that it is required that the portable information electronic device be usable under an extremely severe environment for an electronic device such as (i) under direct sunlight, (ii) under high humidity, (iii) under vibrations mainly due to mounting of the portable information electronic device in a passenger vehicle, or (iv) under pressure or dropping during carriage of the portable information electronic device. For this reason, a solar battery apparatus which is to be mounted in a portable information electronic device and which includes a solar battery cell is required (i) to be resistant to the influence of an external environment and (ii) to be light, thin, short, and small with its portability unimpaired.

A conventional household solar battery apparatus has a feature of being resistant to an external force since a solar battery itself is covered with glass. On the other hand, the conventional household solar battery apparatus has a disadvantage of being heavy and easy to break since a glass substrate serves as a supporting member of the conventional household solar battery apparatus. Therefore, it is impractical to merely reduce the size of such a conventional solar battery apparatus whose supporting member is a glass substrate. Consequently, for a portable information electronic device, there has been suggested a solar battery apparatus reduced in size and weight by substituting a resin substrate or a resin sheet for the glass substrate. However, there occurs such a problem that a solar battery cell constituting the small and light solar battery apparatus is easy to be ruptured by an external physical action and thus an output from the solar battery cell is reduced or is likely to be unobtainable.

Note that a connection between solar battery cells in a solar battery apparatus has conventionally been made as disclosed in Patent Literature 1 or by partially overlapping respective front side electrodes with respective rear side electrodes of the solar battery cells (see FIG. 14). However, it is impossible to employ such a connection method in mounting the solar battery cells in a portable information electronic device, in terms of design or from the viewpoint of strength.

### CITATION LIST

Patent Literature 1

Japanese Utility Model Registration Application, Jitsukaisho, No. 62-157163 A (Publication Date: Oct. 6, 1987)

### SUMMARY OF INVENTION

### Technical Problem

As described earlier, there occurs such a problem that a solar battery cell in a solar battery apparatus reduced in size and weight for a portable information electronic device is easy to be ruptured by an external physical action and thus an output from the solar battery cell is reduced or is likely to be unobtainable.

The present invention has been made in view of the problems, and its object is to provide (i) a solar battery apparatus in which a decrease in power generation capacity of a solar battery cell is prevented even if the solar battery cell is ruptured by a physical force, (ii) a portable electronic device, and (iii) a global positioning system apparatus.

### Solution to Problem

In order to solve the problems, a solar battery apparatus in accordance with the present invention has a plurality of solar battery cells and electrode terminals, other than common electrode terminals, for making an electrical connection (i) between each of the solar battery cells and another or (ii) between the solar battery cell and an external apparatus, the solar battery apparatus including: first connecting means for making an electrical connection between the solar battery cell and the electrode terminals in a plurality of places on the solar battery cell, whereby a decrease in power generation capacity of the solar battery cell is prevented even if the solar battery cell is ruptured by a physical force.

According to the arrangement, the first connecting means make the electrical connection between the solar battery cell and the electrode terminals in the plurality of places on the solar battery cell. This allows prevention of a decrease in power generation capacity of the solar battery cell. This is because the electrical connection is ensured in any part of the solar battery cell even if the solar battery cell is ruptured by a physical force.

### Advantageous Effects of Invention

A solar battery apparatus in accordance with the present invention has a plurality of solar battery cells and electrode terminals, other than common electrode terminals, for making an electrical connection (i) between each of the solar battery cells and another or (ii) between the solar battery cell and an external apparatus, the solar battery apparatus including: first connecting means for making an electrical connection between the solar battery cell and the electrode terminals in a plurality of places on the solar battery cell, whereby a decrease in power generation capacity of the solar battery cell is prevented even if the solar battery cell is ruptured by a physical force.

According to the arrangement, the first connecting means make the electrical connection between the solar battery cell and the electrode terminals in the plurality of places on the solar battery cell. This allows prevention of a decrease in power generation capacity of the solar battery cell. This is because the electrical connection is ensured in any part of the solar battery cell even if the solar battery cell is ruptured by a physical force.

A portable electronic device in accordance with the present invention is mounted with or electrically connected to a solar battery apparatus as mentioned above. A global positioning system apparatus in accordance with the present invention is mounted with or electrically connected to a solar battery apparatus as mentioned above or below.

This brings about an effect of making it possible to provide (i) a solar battery apparatus in which a decrease in power generation capacity of a solar battery cell is prevented even if the solar battery cell is ruptured by a physical force, (ii) a portable electronic device, and (iii) a global positioning system apparatus.

### BRIEF DESCRIPTION OF DRAWINGS

FIG. 1

(a) of FIG. 1, (b) of FIG. 1, and (c) of FIG. 1 are a partial plan view, a partial perspective view, and a cross-sectional view taken along the line A-A′ in (a) of FIG. 1, respectively, of an arrangement of a relevant part of a solar battery apparatus in accordance with an embodiment of the present invention.

FIG. 2

(a) of FIG. 2 and (b) of FIG. 2 are a partial plan view and a cross-sectional view taken along the line A-A′ in (a) of FIG. 2, respectively, of an arrangement of a relevant part of a modification of the solar battery apparatus.

FIG. 3

FIG. 3 illustrates an arrangement of a relevant part of another modification (with a change in disposition of electrode terminals on a solar battery cell) of the solar battery apparatus.

FIG. 4

FIG. 4 illustrates an arrangement of a relevant part of another modification (with a change in the disposition of the electrode terminals on the solar battery cell) of the solar battery apparatus.

FIG. 5

FIG. 5 illustrates an arrangement of a relevant part of another modification (with a change in the disposition of the electrode terminals on the solar battery cell) of the solar battery apparatus.

FIG. 6

FIG. 6 illustrates an arrangement of a relevant part of another modification (with a change in the disposition of the electrode terminals on the solar battery cell) of the solar battery apparatus.

FIG. 7

FIG. 7 illustrates an arrangement of a relevant part of another modification (with a change in the disposition of the electrode terminals on the solar battery cell) of the solar battery apparatus.

FIG. 8

FIG. 8 illustrates an arrangement of a relevant part of still another modification (in which the solar battery cell further includes a connecting section connecting the electrode terminals) of the solar battery apparatus.

FIG. 9

FIG. 9 illustrates an arrangement of a relevant part of still another modification (in which the solar battery cell further includes a connecting section connecting the electrode terminals) of the solar battery apparatus.

FIG. 10

FIG. 10 illustrates an arrangement of a relevant part of still another modification (with a change in shape of the solar battery cell and, accordingly, changes in shapes and disposition of the electrode terminals and the connecting section) of the solar battery apparatus.

FIG. 11

FIG. 11 is a perspective view illustrating a mobile phone in accordance with an embodiment of the present invention, the mobile phone being mounted with a solar battery apparatus.

FIG. 12

FIG. 12 is a perspective view illustrating a portable global positioning apparatus in accordance with an embodiment of the present invention, the portable global positioning apparatus being mounted with a solar battery apparatus.

FIG. 13

FIG. 13 is a perspective view illustrating a digital still camera and a digital video camera in accordance with an embodiment of the present invention, the digital still camera and the digital video camera each being mounted with a solar battery apparatus 10.

FIG. 14

FIG. 14, related to a prior art, illustrates how solar battery cells are connected in a solar battery apparatus.

### DESCRIPTION OF EMBODIMENTS

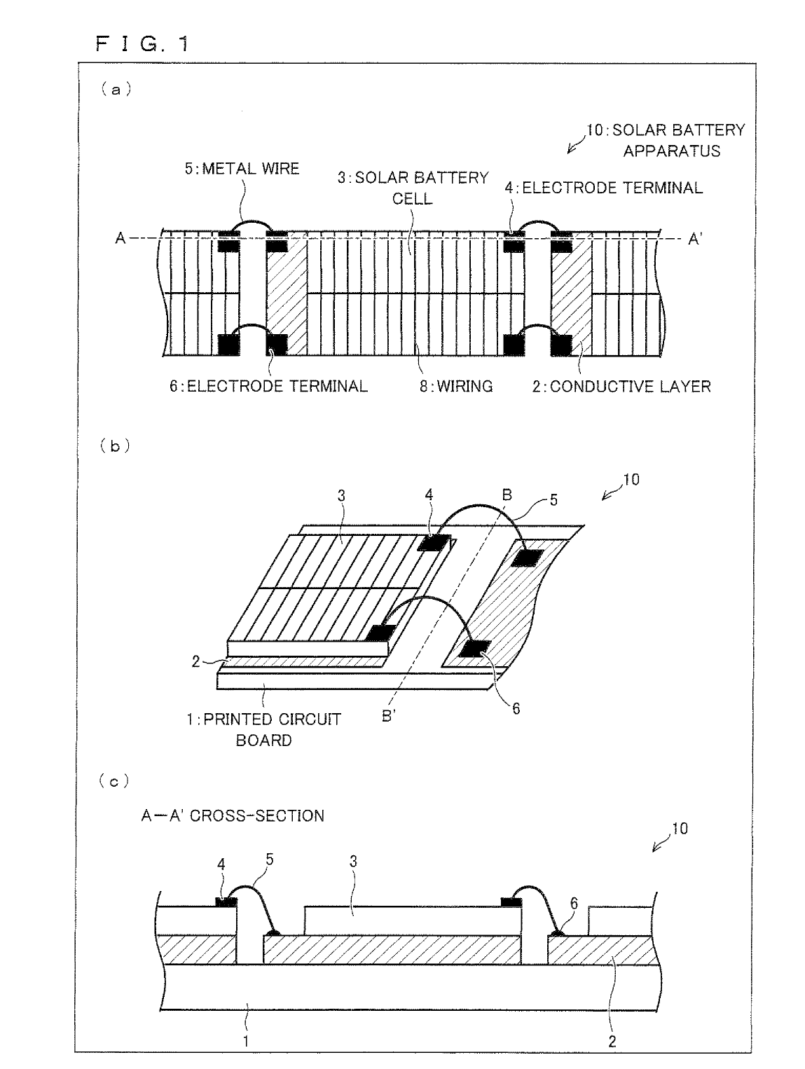

An embodiment of the present invention is described below with reference to FIGS. 1 through 13.

(a) of FIG. 1, (b) of FIG. 1, and (c) of FIG. 1 are a partial plan view, a partial perspective view, and a cross-sectional view taken along the line A-A′ in (a) of FIG. 1, respectively, of an arrangement of a relevant part of a solar battery apparatus 10 in accordance with an embodiment of the present invention. First, the arrangement of the relevant part of the solar battery apparatus 10 is described with reference to FIG. 1.

(Arrangement of the Relevant Part of the Solar Battery Apparatus)

The solar battery apparatus 10 includes a printed circuit board 1, a plurality of conductive layers 2 disposed on the printed circuit board 1, and a plurality of solar battery cells 3 disposed on the plurality of conductive layers 2. The printed circuit board 1 may be a board provided with an insulating section and made of copper, stainless steel, or the like. Each of the conductive layers 2, made of metal such as gold, has a single solar battery cell 3 disposed thereon, and is a little larger in size than the solar battery cell 3. An electrode terminal 6 (an electrode terminal other than a common electrode terminal (not illustrated)) is provided on a part of the conductive layer 2 on which part no solar battery cell 3 is provided. The electrode terminal 6 and the conductive layer 2 are used for connecting to an adjacent solar battery cell 3.

Each of the solar battery cells 3 has a rectangular shape, for example. The solar battery cells 3 are disposed in such a way as to form a rectangular shape, for example. Note that each of the solar battery cells 3 has electrode terminals 4 (electrode terminals other than the common electrode terminals (not illustrated)) provided in at least two places on a top surface thereof. FIG. 1 shows electrode terminals 4 provided on corners of an identical short side of each solar battery cell 3. Each of the electrode terminals 4 is connected to a wire 8, provided on the top surface of the solar battery cell 3, via a metal wire 5 (first connecting means) by wire bonding (although not illustrated, in the same manner as the electrode terminal 4 on the solar battery cell 3 is connected to an electrode terminal 6 on a conductive layer 2 via a metal wire 5). The solar battery cells 3 are electrically connected in such a manner that (i) an electrode terminal 4 on one solar battery cell 3 and (ii) an electrode terminal 6 on the conductive layer 2 on another solar battery cell 3 adjacent to the solar battery cell 3 are connected via a metal wire 5 by wire bonding. Similarly, the solar battery cells 3 are electrically connected to an external apparatus (not illustrated) in such a manner that an electrode terminal 4 on each solar battery cell 3 is connected to an electrode terminal of the external apparatus via a metal wire 5 by wire bonding. Note that the solar battery cells 3 are commonly-used solar battery cells, and as such, are not described in detail. The present embodiment uses, as the solar battery cells 3, solar battery cells each with a length of 10 mm, a width of 15 mm, and a thickness of 160 μm, and uses, as the electrode terminals 4, electrode terminals each square 100 μm on a side.

Each of the metal wires 5 is a metal wire whose cross-section (a cross-section taken along the line B-B′ in (b) of FIG. 1) has a diameter of less than 1 mm. The present embodiment uses a gold wire whose cross-section has a diameter of 25 μm. The metal wire 5 may also be a metal wire made of metal containing copper or aluminum. In a case where the metal wire 5 is made of metal containing copper, it is preferable that the metal wire 5 be coated with a resin so that the metal wire 5 remains conductive without being corroded. Moreover, the metal wire 5 may have a cross-section whose shape is an ellipse or a polygon with three or more sides such as a triangle, a quadrangle, a hexagon, or an octagon.

As described earlier, in the solar battery apparatus 10, a plurality of metal wires 5 are used for making an electrical connection between the solar battery cell 3 and the electrode terminals 4 in a plurality of places on the solar battery cell 3 with the plurality of places located at a desired distance from each other. This allows prevention of a decrease in power generation capacity of the solar battery cell 3. This is because an electrical connection is ensured in any part of the solar battery cell 3 even if the solar battery cell 3 is ruptured by a physical force. The disposition of the electrode terminals 4 as illustrated in FIG. 1 is advantageous in a case where the solar battery cell 3 is ruptured in a horizontal direction with respect to the page. Further, in a case where the solar battery apparatus 10 is mounted in a portable electronic device, the solar battery cells 3 are disposed solely in such a way as to form a rectangular shape and the solar battery cells 3 thus disposed are easy to be ruptured solely in a long side direction.

Furthermore, in the case where the solar battery apparatus 10 is mounted in a portable electronic device, the portable electronic device is mainly exemplified by a mobile phone. In this case, the mobile phone is supposed to be arranged such that a point of connection between the solar battery cell 3 and each of the electrode terminals 4 is included in a frame part of the mobile phone. In this case, such an arrangement is advantageous since it is only necessary to allocate a small area for the point of connection. For example, a metal band for use in connection of a solar battery apparatus is mainly exemplified by a metal band having a transverse length of 1 to 2 mm. However, it is more advantageous, in applying the solar battery apparatus 10 to the portable electronic device, to set the transverse length of the metal band to less than 1 mm as in such an arrangement.

Moreover, such an arrangement allows greater flexibility in wiring, thus making it only necessary to allocate a small area for the point of connection, whereby the area of the solar battery cell 3 can be increased.

(Modifications of the Solar Battery Apparatus)

Next, modifications of the solar battery apparatus 10 are described below. Note that, for convenience of explanation, members having functions identical to the functions of the members shown in the embodiment are given identical reference numerals and an explanation thereof is omitted here. Note also that, basically, only changes from the embodiment are explained.

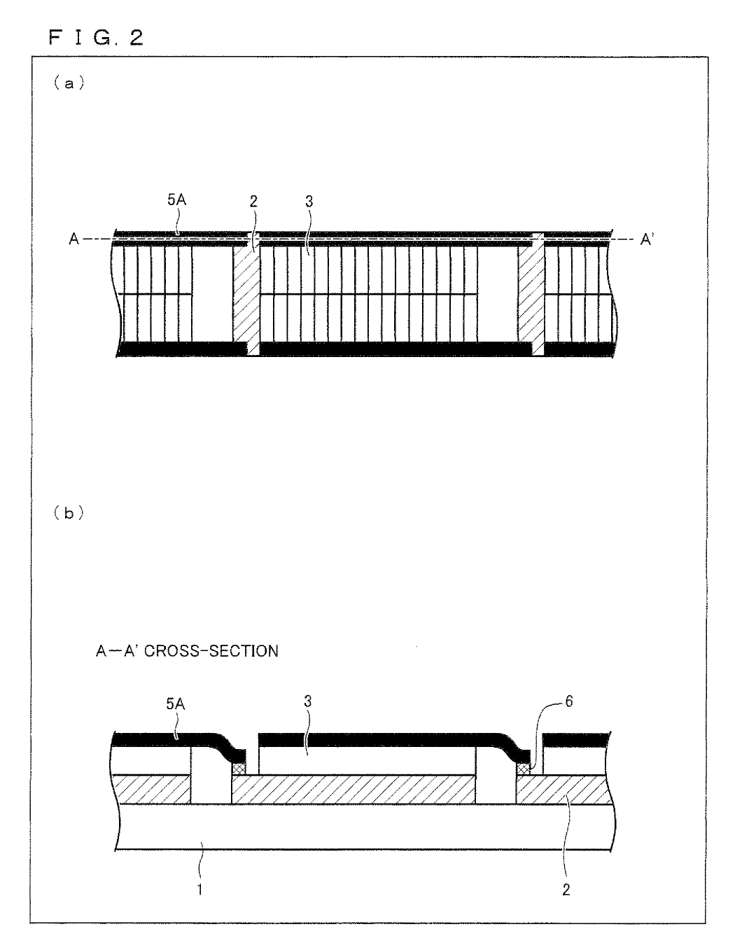

(a) of FIG. 2 and (b) of FIG. 2 are a partial plan view and a cross-sectional view taken along the line A-A′ in (a) of FIG. 2, respectively, of an arrangement of a relevant part of a modification of the solar battery apparatus 10.

In the present modification, each of the metal wires 5 of the solar battery apparatus 10 is replaced by a metal band 5A having a transverse length (length of the line B-B′ in (b) of FIG. 1) of less than 1 mm. The metal band 5A also serves as an electrode terminal 4. The metal band 5A is connected to an electrode terminal 6 (or an electrode terminal of the external apparatus) by soldering. The present embodiment uses, as the metal band 5A, a metal band having a transverse length of 0.8 mm, made basically of copper, and plated with solder. Note, however, that the metal band 5A is not limited to this example, but may be made of such a material as mentioned above or may be a conductive resin material.

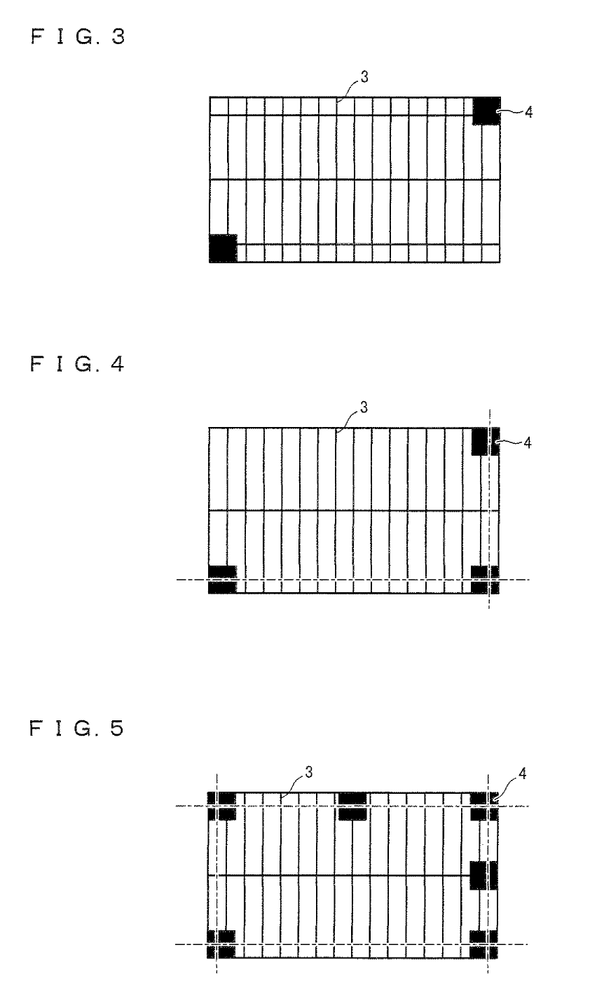

FIGS. 3 through 7 illustrate arrangements of relevant parts of other modifications of the solar battery apparatus 10. Each of the modifications has a change in the disposition of the electrode terminals 4 on the solar battery cell 3.

In a case of FIG. 3, the electrode terminals 4 are diagonally provided on corners of opposite short sides of the solar battery cell 3. In this case, an electrical connection is ensured in the solar battery cell 3 even if the solar battery cell 3 is ruptured in a vertical direction (in a back-and-forth direction with respect to the page) and in the horizontal direction.

In a case of FIG. 4, the electrode terminals 4 are provided on corners of the solar battery cell 3 in such a way as to form the shape of the letter L. Further, in a case of FIG. 5, the electrode terminals 4 are provided on all corners of the solar battery cell 3 and in respective center sections of a single long side and a single short side. This ensures an electrical connection in the solar battery cell 3 with a higher probability since a larger number of electrode terminals 4 are disposed.

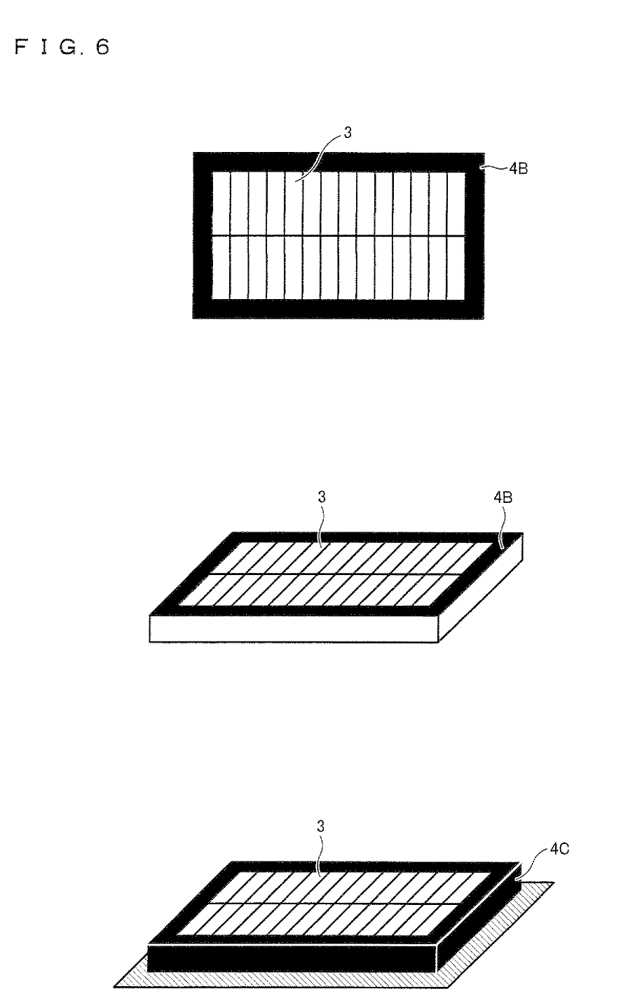

In a case of FIG. 6, the electrode terminals 4 are circularly provided (in a frame shape) in such a way as to continuously cover a rim of the solar battery cell 3 (see an electrode terminal 4B). Furthermore, the electrode terminals 4 may be arranged to cover not only the rim of the solar battery cell 3 but also side surfaces of the solar battery cell 3 (see an electrode terminal 4C). The electrode terminal 4B and the electrode terminal 4C are made of a material similar to the material of which the metal band 5A is made. Such structures as the electrode terminal 4B and the electrode terminal 4C ensure an electrical connection in the solar battery cell 3 with the highest probability among the aforementioned arrangements of the electrode terminals 4.

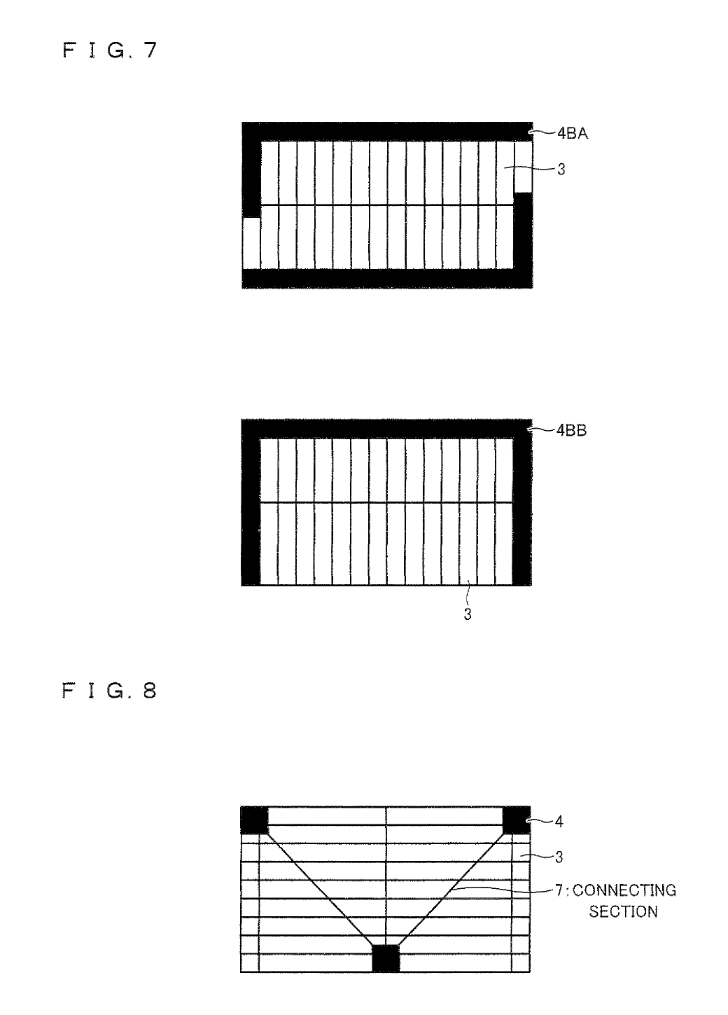

In a case of FIG. 7, the electrode terminals 4 are circularly provided (in a frame shape) in such a way as to partially cover the rim of the solar battery cell 3 (see an electrode terminal 4BA and an electrode terminal 4BB). Namely, the electrode terminal 4BA and the electrode terminal 4BB are each obtained by causing the electrode terminal 4B to be partially missing. Examples of how the electrode terminals 4 are disposed, how they are structured, and what they are made of are not limited to those described above in the modifications. Particularly, as for the examples of how the electrode terminals 4 are disposed, it is only necessary to provide the electrode terminals 4 on (i) four corners, (ii) four sides, and (iii) both (i) and (ii) of the solar battery cell 3 in consideration of a direction in which the solar battery cell 3 is easy to be ruptured, in order that an electrical connection is ensured in the solar battery cell 3 when the solar battery cell 3 is ruptured in that direction.

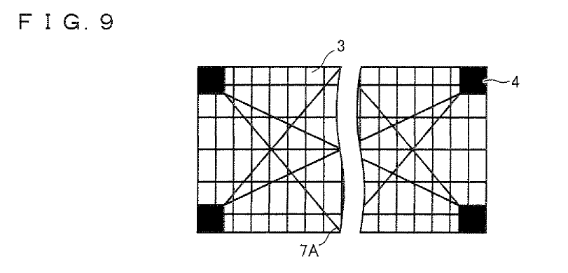

FIGS. 8 and 9 illustrate arrangements of relevant parts of still other modifications of the solar battery apparatus 10. In the present modifications, the solar battery cells 3 are further provided with connecting sections (second connecting means) 7 and 7A, respectively, which connect the electrode terminals 4. The provision of the connecting section 7 or 7A that connects the electrode terminals 4 ensures an electrical connection in the solar battery cell 3 with a higher probability, thus allowing more secure prevention of a decrease in power generation capacity of the solar battery cell 3. The present embodiment uses, as the connecting sections 7 and 7A, connecting sections made of metal containing silver. However, the connecting sections 7 and 7A are not limited to this example, but may be made of gold or aluminum as mentioned above.

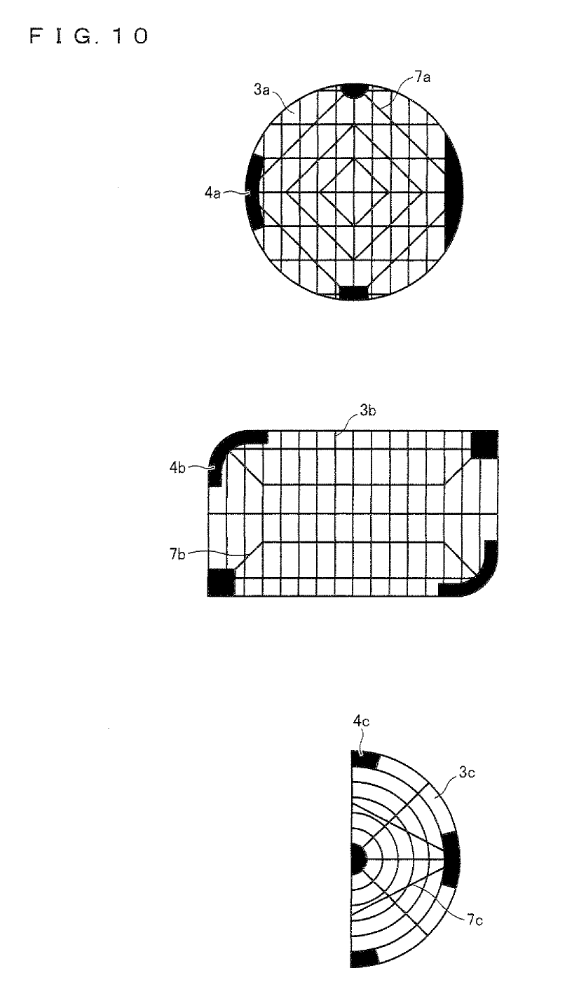

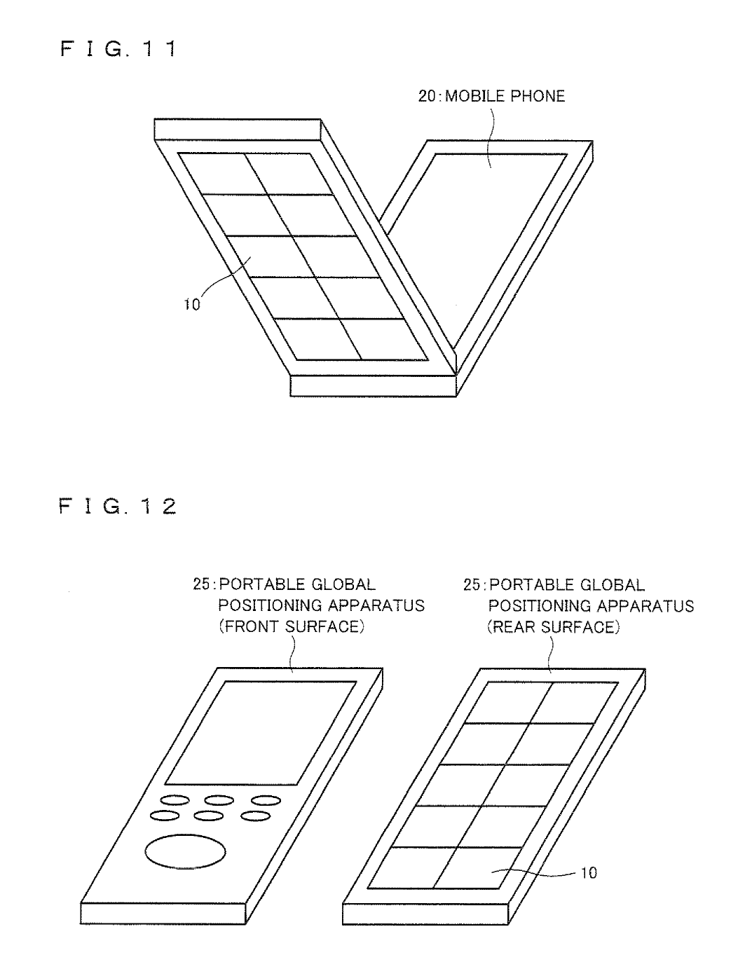

FIG. 10 illustrates an arrangement of a relevant part of still another modification of the solar battery apparatus 10. The present modification has a change in shape of the solar battery cell 3 and, accordingly, changes in shapes and disposition of the electrode terminals 4 and the connecting section 7. Namely, the solar battery cell 3 may be shaped into a circle (see a solar battery cell 3a) or a semicircle (see a solar battery cell 3c). The electrode terminals 4 are, for example, (i) shaped along the circumference of the solar battery cell 3a or the solar battery cell 3c, (ii) shaped into a semicircle, or (iii) provided in a center section of the circle (see electrode terminals 4a and 4c). Moreover, the connecting sections 7 are diamond-shaped or radially-shaped accordingly (see connecting sections 7a and 7c). Further, the solar battery cell 3 may be shaped into a rectangle (see a solar battery cell 3b) not all four corners of which are right-angled, and the electrode terminals 4 and the connecting sections 7 may be shaped accordingly (see electrode terminals 4b and connecting sections 7b).

(Examples of Applications of the Solar Battery Apparatus)

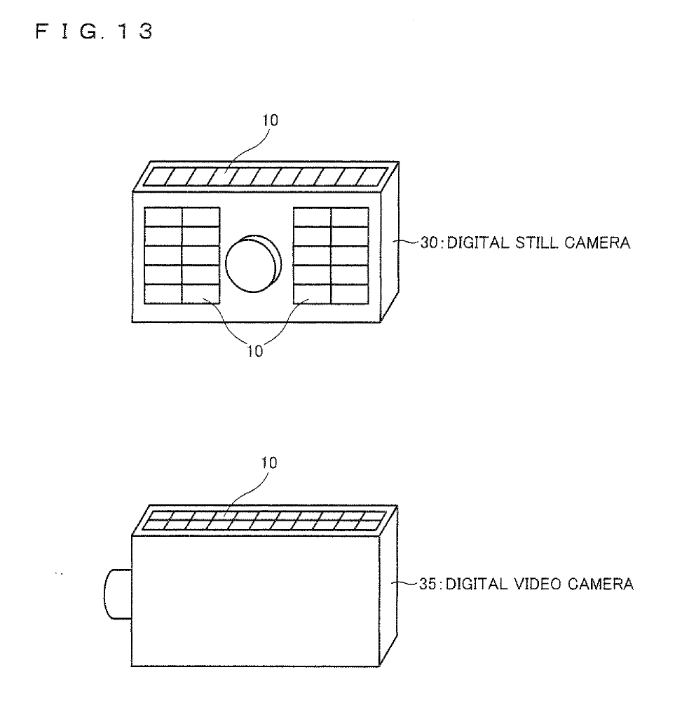

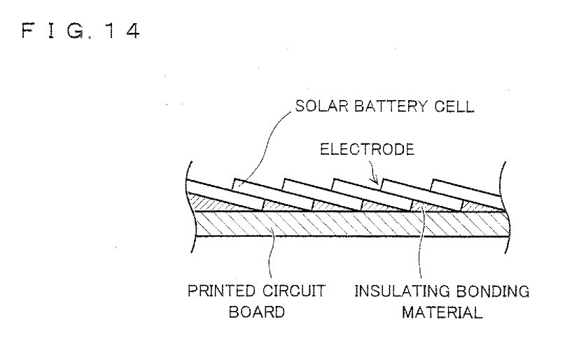

Examples of applications of the solar battery apparatus 10 are described below. FIG. 11 is a perspective view of a mobile phone (portable electronic device) 20 mounted with the solar battery apparatus 10 (or electrically connected to the solar battery 10). FIG. 12 is a perspective view of a portable global positioning apparatus (global positioning system apparatus or GPS) (which may also be an in-vehicle global positioning apparatus) 25. FIG. 13 shows perspective views of a digital still camera (portable electronic device) 30 and a digital video camera (portable electronic device) 35 each mounted with the solar battery apparatus 10 (or electrically connected to the solar battery apparatus 10).

For example, the mobile phone 20 and the portable global positioning apparatus 25 each have the solar battery apparatus 10 mounted on the rear surface thereof. For example, the digital still camera 30 and the digital video camera 35 each have the solar battery apparatus 10 mounted on the top surface or side surface thereof. Since various devices and apparatuses cited above are commonly used, a detailed explanation thereof is omitted here. In each of these devices and apparatuses, the solar battery apparatus 10 generates electric power with sunlight and supplies the electric power thus generated to an electric power source such as a secondary cell provided in each of the devices and apparatuses. As described earlier, it is only necessary, in the solar battery apparatus 10, to allocate a small area for the point of connection between the solar battery cell 3 and each of the electrode terminals 4. This is advantageous in applying the solar battery apparatus 10 to a portable electronic device. Furthermore, even if the solar battery cell 3 is ruptured by a physical force, an electrical connection is ensured in any part of the solar battery cell 3, whereby a decrease in power generation capacity of the solar battery cell 3 can be prevented. Therefore, the devices and apparatuses each mounted with the solar battery apparatus 10 allow an increase in their portability and operational reliability as compared with those each mounted with a conventional solar battery apparatus.

### Summary of the Embodiments

A portable electronic device in accordance with the embodiment of the present invention is mounted with or electrically connected to the solar battery apparatus 10. It is preferable that the portable electronic device be the mobile phone 20, the digital still camera 30, or the digital video camera 35.

The global positioning apparatus 25 in accordance with the embodiment of the present invention is mounted with or electrically connected to the solar battery apparatus 10.

This brings about an effect of making it possible to provide (i) the solar battery apparatus 10 in which a decrease in power generation capacity of the solar battery cell 3 is prevented even if the solar battery cell 3 is ruptured by a physical force, (ii) the portable electronic device, and (iii) the portable global positioning apparatus 25.

The solar battery apparatus 10 in accordance with the embodiment of the present invention is preferably arranged such that each of the first connecting means is the metal wire 5 whose cross-section has a diameter of less than 1 mm.

The portable information electronic device in which the solar battery apparatus 10 is mounted is mainly exemplified by the mobile phone 20. In this case, the mobile phone 20 is supposed to be arranged such that a point of connection between the solar battery cell 3 and each of the electrode terminals 4 is included in a frame part of the mobile phone 20. In this case, such an arrangement is advantageous since it is only necessary to allocate a small area for the point of connection. For example, the metal band 5A for use in connection of a solar battery apparatus is mainly exemplified by a metal band having a transverse length of 1 to 2 mm. However, it is more advantageous, in applying the solar battery apparatus 10 to the portable information electronic device, to set the transverse length of the metal band 5A to less than 1 mm as in the arrangement.

Moreover, such an arrangement allows greater flexibility in wiring, thus making it only necessary to allocate a small area for the point of connection, whereby the area of the solar battery cell 3 can be increased.

The solar battery apparatus 10 in accordance with the embodiment of the present invention is preferably arranged such that the metal wire 5 has a cross-section whose shape is a polygon with three or more sides.

The solar battery apparatus 10 in accordance with the embodiment of the present invention is preferably arranged such that each of the first connecting means is the metal band 5A having a transverse length of less than 1 mm.

The arrangement makes it possible, too, to bring about an effect similar to an effect brought about in the case where each of the first connecting means is a metal wire 5.

The solar battery apparatus 10 in accordance with the embodiment of the present invention is preferably arranged such that the electrode terminals 4 are provided in at least two places on the solar battery cell 3.

The solar battery apparatus 10 in accordance with the embodiment of the present invention is preferably arranged such that: the electrode terminals 4 are provided along (i) sides, (ii) corners, or (iii) both (i) and (ii) of the solar battery cell 3 in a case where the solar battery cell 3 has a rectangular shape or a rectangular shape not all four corners of which are right-angled; and the electrode terminals 4 are provided (i) along a circumference, (ii) in a center section, or (iii) (i) and (ii) of the solar battery cell 3 in a case where the solar battery cell 3 has a circular shape.

The electrode terminals 4 only needs to be disposed in consideration of a direction in which the solar battery cell 3 is easy to be ruptured, in order that an electrical connection is ensured in the solar battery cell 3 when the solar battery cell 3 is ruptured in that direction. This ensures an electrical connection in the solar battery cell 3 with a higher probability, thus allowing more secure prevention of a decrease in power generation capacity of the solar battery cell 3.

The solar battery apparatus 10 in accordance with the embodiment of the present invention is preferably arranged such that the electrode terminals 4 are circularly provided in such a way as to cover at least a part of a rim of the solar battery cell 3.

According to the arrangement, it is possible to most securely prevent a decrease in power generation capacity of the solar battery cell 3. This is because an electrical connection is most securely ensured in the solar battery cell 3 particularly in a case where the electrode terminals are circularly provided so as to continuously and entirely cover the rim of the solar battery cell 3.

The solar battery apparatus 10 in accordance with the embodiment of the present invention is preferably arranged to further include the connecting section 7 or 7A connecting the electrode terminals 4.

According to the arrangement, the provision of the connecting section 7 or 7A that connects the electrode terminals 4 ensures an electrical connection in the solar battery cell 3 with a higher probability, thus allowing more secure prevention of a decrease in power generation capacity of the solar battery cell 3.

The solar battery apparatus 10 in accordance with the embodiment of the present invention is preferably arranged such that: the electrode terminals 4 are provided in such a shape as to be mutually electrically conducted; and each of the electrode terminals 4 is made of metal or a conductive material containing metal.

The solar battery apparatus 10 in accordance with the embodiment of the present invention is preferably arranged such that the metal wire 5 is made of metal containing gold, copper, or aluminum.

The solar battery apparatus 10 in accordance with the embodiment of the present invention is preferably arranged such that the metal wire 5 is coated with a resin in a case where the metal wire 5 is made of metal containing copper.

According to the arrangement, it is possible to avoid corrosion of the metal wire 5 so that the metal wire 5 can remain conductive.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

A solar battery apparatus in accordance with the present invention is arranged such that even if a solar battery cell is ruptured by a physical force, an electrical connection is ensured in any part of the solar battery cell, whereby a decrease in power generation capacity of the solar battery cell can be prevented. The solar battery apparatus in accordance with the present invention is suitably applicable to portable electronic devices such as a mobile phone, a digital still camera, and a digital video camera, and to a global positioning apparatus and the like.

### REFERENCE SIGNS LIST

3 Solar battery cell

4 Electrode terminal

5 Metal wire (first connecting means)

5A Metal band (first connecting means)

7, 7A Connecting section (Second connecting means)

10 Solar battery apparatus

20 Mobile phone (portable electronic device)

25 Portable global positioning apparatus (global positioning system apparatus)

30 Digital still camera (portable electronic device)

35 Digital video camera (portable electronic device)

1. A solar battery apparatus having a plurality of solar battery cells and electrode terminals, other than common electrode terminals, for making an electrical connection (i) between each of the solar battery cells and another or (ii) between the solar battery cell and an external apparatus, the solar battery apparatus comprising:
first connecting means for making an electrical connection between the solar battery cell and the electrode terminals in a plurality of places on the solar battery cell, whereby a decrease in power generation capacity of the solar battery cell is prevented even if the solar battery cell is ruptured by a physical force.

2. The solar battery apparatus as set forth in claim 1, wherein each of the first connecting means is a metal wire whose cross-section has a diameter of less than 1 mm.

3. The solar battery apparatus as set forth in claim 2, wherein the metal wire has a cross-section whose shape is a polygon with three or more sides.

4. The solar battery apparatus as set forth in claim 1, wherein each of the first connecting means is a metal band having a transverse length of less than 1 mm.

5. The solar battery apparatus as set forth in claim 1, wherein the electrode terminals are provided in at least two places on the solar battery cell.

6. The solar battery apparatus as set forth in claim 5, wherein:
the electrode terminals are provided along (i) sides, (ii) corners, or (iii) both (i) and (ii) of the solar battery cell in a case where the solar battery cell has a rectangular shape or a rectangular shape not all four corners of which are right-angled; and
the electrode terminals are provided (i) along a circumference, (ii) in a center section, or (iii) (i) and (ii) of the solar battery cell in a case where the solar battery cell has a circular shape.

7. The solar battery apparatus as set forth in claim 5, wherein the electrode terminals are circularly provided in such a way as to cover at least a part of a rim of the solar battery cell.

8. The solar battery apparatus as set forth in claim 5, further comprising second connecting means for connecting the electrode terminals.

9. The solar battery apparatus as set forth in claim 1, wherein:
the electrode terminals are provided in such a shape as to be mutually electrically conducted; and
each of the electrode terminals is made of metal or a conductive material containing metal.

10. The solar battery apparatus as set forth in claim 2, wherein the metal wire is made of metal containing gold, copper, or aluminum.

11. The solar battery apparatus as set forth in claim 10, wherein the metal wire is coated with a resin in a case where the metal wire is made of metal containing copper.

12. A portable electronic device mounted with or electrically connected to a solar battery apparatus recited in claim 1.

13. The portable information electronic device as set forth in claim 12, wherein the portable electronic device is a mobile phone, a digital still camera, or a digital video camera.

14. A global positioning system apparatus mounted with or electrically connected to a solar battery apparatus recited in claim 1.
